(19) United States
(12) Patent Application Publication
(10) Pub. No.: US 2015/0145735 A1
(43) Pub. Date: May 28, 2015

(54) Antenna

(71) Applicant: Huawei Device Co., Ltd., Shenzhen (CN)

(72) Inventors: Yi Fan, Shenzhen (CN); Bo Meng, Shenzhen (CN); Dongxing Tu, Shenzhen (CN); Shuhui Sun, Shenzhen (CN); Zhongying Long, Shenzhen (CN)

(21) Appl. No.: 14/586,465

(22) Filed: Dec. 30, 2014

Related U.S. Application Data
(63) Continuation of application No. PCT/CN2013/087692, filed on Nov. 22, 2013.

(51) Int. Cl. H01Q 7/00; H01Q 9/04

(52) U.S. Cl. CPC H01Q 7/00; H01Q 9/0407
USPC 343/722

(57) ABSTRACT

The present invention discloses an antenna and pertains to the field of communications technologies. The antenna includes: a printed circuit board, a first antenna feeding structure, a first antenna loading structure, and a first filter, where the first antenna feeding structure has a grounding pin and a feeding pin, the grounding pin and the feeding pin are separately connected to the printed circuit board, and the first antenna loading structure and a partial structure of the first antenna feeding structure form a coupling structure; and the first antenna loading structure is connected to the first filter, the first filter is connected to the printed circuit board, and the first filter is configured to cut off a low-frequency current. A low-frequency current is cut off by using a filter, so as to implement selective filtering for an antenna loading structure and extend operating bandwidth of the antenna.

This application claims the benefit of International Application No. PCT/CN2013/087692, filed on Nov. 22, 2013, which application is hereby incorporated by reference.

### TECHNICAL FIELD

The present invention relates to the field of communications technologies, and in particular, to an antenna.

### BACKGROUND

With the development of communications technologies, a terminal device sends and receives a signal by using a built-in antenna to implement real-time communication. The development of LTE (Long Term Evolution, Long Term Evolution) imposes an increasingly higher requirement on antenna bandwidth, and 2G, 3G, and 4G bands are all covered, which brings about a great challenge to an antenna design.

A built-in antenna in a form of monopole, IFA, or PIFA is widely used in an existing terminal device, the built-in antenna and a PCB jointly form a radiator, and the radiator is configured to receive and send a signal, which optimizes antenna performance.

During the implementation of the present invention, the inventor finds that the prior art has at least the following problem:

In the prior art, a built-in antenna in a form of monopole, IFA, or PIFA can enhance antenna performance, but cannot further extend antenna bandwidth and cannot meet an actual use requirement.

### SUMMARY

In order to resolve a problem of extending antenna bandwidth, embodiments of the present invention provide an antenna. The technical solutions are as follows:

According to a first aspect, an antenna is provided, where the antenna includes:

a printed circuit board, a first antenna feeding structure, a first antenna loading structure, and a first filter, where

the first antenna feeding structure has a grounding pin and a feeding pin, the grounding pin and the feeding pin are separately connected to the printed circuit board, and the first antenna loading structure and a partial structure of the first antenna feeding structure form a coupling structure; and

the first antenna loading structure is connected to the first filter, the first filter is connected to the printed circuit board, and the first filter is configured to cut off a low-frequency current.

With reference to the first aspect, in a first possible implementation manner of the first aspect, the first antenna feeding structure is configured to implement radiation of a ¼ wavelength of a low-frequency signal or radiation of a ½ wavelength of a high-frequency signal.

With reference to the first aspect or the first possible implementation manner of the first aspect, in a second possible implementation manner of the first aspect, the printed circuit board is a quadrilateral, and the quadrilateral includes a lateral side and a vertical side.

With reference to the second possible implementation manner of the first aspect, in a third possible implementation manner of the first aspect, that the grounding pin and the feeding pin are separately connected to the printed circuit board includes that:

the grounding pin and the feeding pin are separately connected to the lateral side of the printed circuit board.

With reference to the second possible implementation manner of the first aspect or the third possible implementation manner of the first aspect, in a fourth possible implementation manner of the first aspect, that the first filter is connected to the printed circuit board includes that:

the first filter is connected to the vertical side of the printed circuit board.

With reference to the second possible implementation manner of the first aspect or the fourth possible implementation manner of the first aspect, in a fifth possible implementation manner of the first aspect, the first antenna feeding structure is an L-shaped structure, where the L-shaped structure includes:

a short cable disposed opposite to the lateral side of the printed circuit board and a long cable disposed opposite to the vertical side of the printed circuit board.

With reference to any implementation manner of the second possible implementation manner of the first aspect to the fifth possible implementation manner of the first aspect, in a sixth possible implementation manner of the first aspect, the first antenna loading structure is disposed opposite to the vertical side of the printed circuit board.

With reference to the fifth possible implementation manner of the first aspect or the sixth possible implementation manner of the first aspect, in a seventh possible implementation manner of the first aspect, that the first antenna loading structure and a partial structure of the first antenna feeding structure form a coupling structure includes that:

the first antenna loading structure and the long cable of the first antenna feeding structure form the coupling structure.

With reference to the seventh possible implementation manner of the first aspect, in an eighth possible implementation manner of the first aspect, the printed circuit board, the short cable, and the coupling structure form an equivalent loop antenna, where the equivalent loop antenna is configured for radiation of a high-frequency signal.

With reference to any implementation manner of the first aspect to the eighth possible implementation manner of the first aspect, in a ninth possible implementation manner of the first aspect, the antenna further includes:

a second antenna feeding structure, a neutralizing wire, a second antenna loading structure, and a second filter, where

the second antenna feeding structure has a second feeding pin, and the second feeding pin is connected to the printed circuit board;

the first antenna feeding structure and the second antenna feeding structure are connected by using the neutralizing wire, and the first antenna feeding structure and the second antenna feeding structure share the grounding pin; and

the second antenna loading structure is connected to the second filter, and the second filter is connected to the printed circuit board.

With reference to the ninth possible implementation manner of the first aspect, in a tenth possible implementation manner of the first aspect, the first filter and the second filter are low-frequency band-stop filters.

Beneficial effects brought about by the technical solutions provided by the embodiments of the present invention are as follows:

The embodiments of the present invention provide an antenna, and the antenna includes: a printed circuit board, a first antenna feeding structure, a first antenna loading structure, and a first filter, where the first antenna feeding structure has a grounding pin and a feeding pin, the grounding pin and the feeding pin are separately connected to the printed circuit board, and the first antenna loading structure and a partial structure of the first antenna feeding structure form a coupling structure; and the first antenna loading structure is connected to the first filter, the first filter is connected to the printed circuit board, and the first filter is configured to cut off a low-frequency current. A low-frequency current is cut off by using a filter, so as to implement selective filtering for an antenna loading structure and extend operating bandwidth of the antenna.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a structural diagram of an antenna according to Embodiment 1 of the present invention; and

FIG. 2 is a structural diagram of an antenna according to Embodiment 2 of the present invention.

### DETAILED DESCRIPTION OF ILLUSTRATIVE EMBODIMENTS

To make the objectives, technical solutions, and advantages of the present invention clearer, the following further describes the embodiments of the present invention in detail with reference to the accompanying drawings.

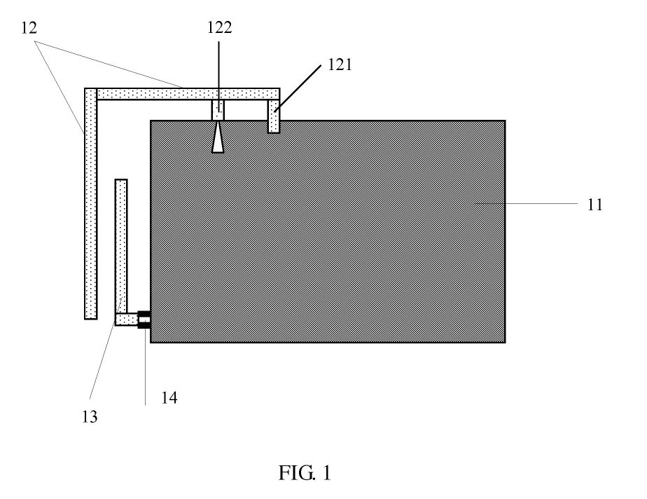

FIG. 1 is a structural diagram of an antenna according to Embodiment 1 of the present invention. Referring to FIG. 1, the antenna at least includes:

a printed circuit board 11, a first antenna feeding structure 12, a first antenna loading structure 13, and a first filter 14, where

the first antenna feeding structure 12 has a grounding pin 121 and a feeding pin 122, the grounding pin 121 and the feeding pin 122 are separately connected to the printed circuit board 11, and a current of the first antenna loading structure 13 and a partial structure of the first antenna feeding structure 12 form a coupling structure; and

the first antenna loading structure 13 is connected to the first filter 14, the first filter 14 is connected to the printed circuit board 11, and the first filter 14 is configured to cut off a low-frequency current.

The printed circuit board 11 is configured to connect an electronic component required by the antenna.

The first antenna feeding structure 12 is configured to transmit a high-frequency current and a low-frequency current, so as to implement low-frequency and high-frequency operating modes. The grounding pin 121 is configured to implement grounding of the first antenna feeding structure 12. The feeding pin 122 is configured to connect the first antenna feeding structure 12 to the printed circuit board 11, so as to implement a circuit connection and form a complete loop.

Because high-frequency bandwidth loaded by the first antenna feeding structure 12 cannot meet an actual requirement, the first loading structure 13 is configured to extend the high-frequency bandwidth. By means of coupling the first antenna feeding structure 12 and the first antenna loading structure 13, on the one hand, high-frequency current coupling extends the high-frequency bandwidth, and on the other hand, low-frequency current coupling attenuates low-frequency bandwidth.

In order to reduce attenuation of the low-frequency bandwidth when the first antenna feeding structure 12 is coupled with the first antenna loading structure 13, the low-frequency current is cut off by means of selective filtering performed by the first filter 14 on the first antenna loading structure 13. Then, when the first antenna feeding structure 12 is coupled with the first antenna loading structure 13, extension of the high-frequency bandwidth may be implemented without affecting the low-frequency bandwidth.

Embodiments of the present invention provide an antenna, and the antenna includes: a printed circuit board, a first antenna feeding structure, a first antenna loading structure, and a first filter, where the first antenna feeding structure has a grounding pin and a feeding pin, the grounding pin and the feeding pin are separately connected to the printed circuit board, and the first antenna loading structure and a partial structure of the first antenna feeding structure form a coupling structure; and the first antenna loading structure is connected to the first filter, the first filter is connected to the printed circuit board, and the first filter is configured to cut off a low-frequency current. A low-frequency current is cut off by using a filter, so as to implement selective filtering for an antenna loading structure and extend operating bandwidth of the antenna.

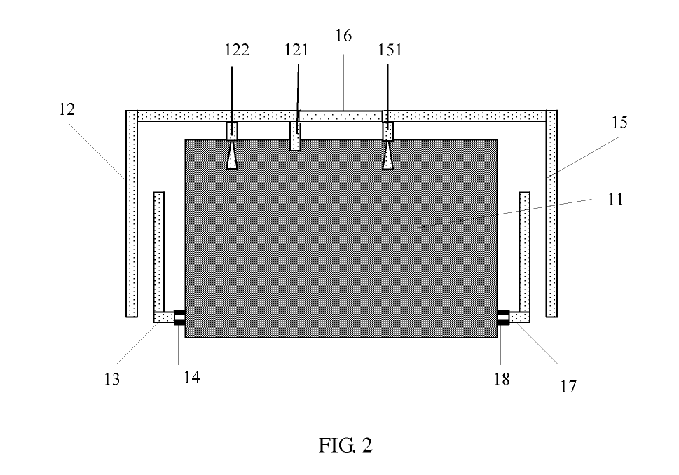

FIG. 2 is a structural diagram of an antenna according to Embodiment 2 of the present invention. Referring to FIG. 2, the antenna is corresponding to a multiple-input multiple-output mode, and the antenna includes:

a printed circuit board 11, a first antenna feeding structure 12, a first antenna loading structure 13, and a first filter 14, where

the first antenna feeding structure 12 has a grounding pin 121 and a feeding pin 122, the grounding pin 121 and the feeding pin 122 are separately connected to the printed circuit board 11, and the first antenna loading structure 13 and a partial structure of the first antenna feeding structure 12 form a coupling structure; and

the first antenna loading structure 13 is connected to the first filter 14, the first filter 14 is connected to the printed circuit board 11, and the first filter 14 is configured to cut off a low-frequency current.

A shape of the first antenna loading structure 13 is a bar; a material of the first antenna loading structure 13 may be a copper material, and may also be an alloy material of other metals.

The first antenna feeding structure 12 is configured to implement radiation of a ¼ wavelength of a low-frequency signal or radiation of a ½ wavelength of a high-frequency signal.

The printed circuit board 11 is a quadrilateral, and the quadrilateral includes a lateral side and a vertical side.

That the grounding pin 121 and the feeding pin 122 are separately connected to the printed circuit board 11 includes that:

the grounding pin 121 and the feeding pin 122 are separately connected to the lateral side of the printed circuit board.

That the first filter 14 is connected to the printed circuit board 11 includes that:

the first filter 14 is connected to the vertical side of the printed circuit board.

The first antenna feeding structure 12 is an L-shaped structure, and the L-shaped structure includes:

a short cable disposed opposite to the lateral side of the printed circuit board 11 and a long cable disposed opposite to the vertical side of the printed circuit board 11.

The first antenna loading structure 13 is disposed opposite to the vertical side of the printed circuit board 11.

That the first antenna loading structure 13 and a partial structure of the first antenna feeding structure 12 form a coupling structure includes that:

the first antenna loading structure 13 and the long cable of the first antenna feeding structure 12 form the coupling structure.

The printed circuit board 11, the short cable, and the coupling structure form an equivalent loop antenna, and the equivalent loop antenna is configured for radiation of a high-frequency signal.

Two sides of the L-shaped first antenna feeding structure 12 are perpendicular to each other, and are parallel to the lateral side and the vertical side of the printed circuit board 11 respectively. The side that is parallel to the lateral side of the printed circuit board 11 in the L-shaped first antenna feeding structure 12 is a short cable, and the short cable is connected to the lateral side of the printed circuit board 11 by using the feeding pin 121 and the feeding pin 122. The side that is parallel to the vertical side of the printed circuit board 11 in the L-shaped first antenna feeding structure 12 is a long cable. The L-shaped first antenna feeding structure 12 may be a copper material, and may also be an alloy material of other metals.

The antenna may further include:

a second antenna feeding structure 15, a neutralizing wire 16, a second antenna loading structure 17, and a second filter 18, where

the second antenna feeding structure 15 has a second feeding pin 151, and the second feeding pin 151 is connected to the printed circuit board 11;

the first antenna feeding structure 12 and the second antenna feeding structure 15 are connected by using the neutralizing wire 16, and the first antenna feeding structure 12 and the second antenna feeding structure 15 share the grounding pin 121; and

the second antenna loading structure 17 is connected to the second filter 18, and the second filter 18 is connected to the printed circuit board 11.

The first filter 14 and the second filter 18 are low-frequency band-stop filters.

The first antenna feeding structure 12 and the second antenna feeding structure 15 may be different-side parallel cabling, same-side parallel (but disconnected) cabling, same-side parallel cabling without shared grounding, or same-side cabling with shared grounding (connected by using the neutralizing wire 16). Preferably, the first antenna feeding structure 12 and the second antenna feeding structure 15 are same-side cabling with shared grounding (connected by using the neutralizing wire 16). A resonant structure formed by using the same-side cabling with shared grounding may effectively resolve a low-frequency isolation problem of a multiple-input multiple-output mode antenna.

The neutralizing wire 16 enables the first antenna feeding structure 12 and the second antenna feeding structure 15 to share grounding, so as to achieve a high-isolation multiple-input multiple-output antenna design.

The first antenna loading structure 13 and the second antenna loading structure 17 may cause deterioration in low-frequency performance of the antenna. The low-frequency current is cut off when the first filter 14 and the second filter 18 are low-frequency band-stop filters, so that impact of the first antenna loading structure 13 and the second antenna loading structure 17 on a low frequency is greatly reduced, thereby implementing extension of an antenna operating frequency.

The multiple-input multiple-output mode antenna is formed by the printed circuit board 11, the first antenna feeding structure 12, the first antenna loading structure 13, the first filter 14, the second antenna feeding structure 15, the neutralizing wire 16, the second antenna loading structure 17, and the second filter 18, and the multiple-input multiple-output mode antenna has a multi-mode radiation function. Firstly, a low-frequency ¼ wavelength radiation mode and a high-frequency ½ wavelength radiation mode are formed by the L-shaped first antenna feeding structure 12; secondly, an equivalent loop antenna is formed by the printed circuit board 11, the short cable, and the coupling structure and implements a radiation mode for higher-frequency signal loading, thereby implementing extension of an antenna operating frequency.

The embodiments of the present invention provide an antenna, and the antenna includes: a printed circuit board, a first antenna feeding structure, a first antenna loading structure, and a first filter, where the first antenna feeding structure has a grounding pin and a feeding pin, the grounding pin and the feeding pin are separately connected to the printed circuit board, and the first antenna loading structure and a partial structure of the first antenna feeding structure form a coupling structure; and the first antenna loading structure is connected to the first filter, the first filter is connected to the printed circuit board, and the first filter is configured to cut off a low-frequency current. A low-frequency current is cut off by using a filter, so as to implement selective filtering for an antenna loading structure and extend operating bandwidth of the antenna, and the L-shaped first antenna feeding structure and the second antenna feeding structure effectively resolve a low-frequency isolation problem by using same-side cabling with common grounding.

A person of ordinary skill in the art may understand that all or a part of the steps of the embodiments may be implemented by hardware or a program instructing relevant hardware. The program may be stored in a computer readable storage medium. The storage medium may include a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. An antenna, comprising:
a printed circuit board;
a first antenna feeding structure having a grounding pin and a feeding pin, wherein the grounding pin and the feeding pin are separately connected to the printed circuit board;
a first antenna loading structure, wherein the first antenna loading structure and a partial structure of the first antenna feeding structure form a coupling structure; and
a first filter;
wherein the first antenna loading structure is connected to the first filter, the first filter is connected to the printed circuit board, and the first filter is configured to cut off a low-frequency current.

2. The antenna according to claim 1, wherein the first antenna feeding structure is configured to implement at least one of radiation of a ¼ wavelength of a low-frequency signal or radiation of a ½ wavelength of a high-frequency signal.

3. The antenna according to claim 1, wherein the printed circuit board is a quadrilateral, and wherein the quadrilateral comprises a lateral side and a vertical side.

4. The antenna according to claim 3, wherein the grounding pin and the feeding pin are separately connected to the lateral side of the printed circuit board.

5. The antenna according to claim 3, wherein the first filter is connected to the vertical side of the printed circuit board.

6. The antenna according to claim 3, wherein the first antenna loading structure is disposed opposite to the vertical side of the printed circuit board.

7. The antenna according to claim 3, wherein the first antenna feeding structure is an L-shaped structure comprising:
a short cable disposed opposite to the lateral side of the printed circuit board; and
a long cable disposed opposite to the vertical side of the printed circuit board.

8. The antenna according to claim 7, wherein the first antenna loading structure and the long cable of the first antenna feeding structure form the coupling structure.

9. The antenna according to claim 8, wherein the printed circuit board, the short cable, and the coupling structure form an equivalent loop antenna; and
wherein the equivalent loop antenna is configured for radiation of a high-frequency signal.

10. The antenna according to claim 1, further comprising:
a second antenna feeding structure;
a neutralizing wire;
a second antenna loading structure; and
a second filter;
wherein the second antenna feeding structure has a second feeding pin, and the second feeding pin is connected to the printed circuit board;
wherein the first antenna feeding structure and the second antenna feeding structure are connected by using the neutralizing wire, and the first antenna feeding structure and the second antenna feeding structure share the grounding pin; and
wherein the second antenna loading structure is connected to the second filter, and the second filter is connected to the printed circuit board.

11. The antenna according to claim 10, wherein the first filter and the second filter are low-frequency band-stop filters.
